(19) United States
(12) Patent Application Publication
(10) Pub. No.: US 2021/0166058 A1
(43) Pub. Date: Jun. 3, 2021

(54) IMAGE GENERATION METHOD AND COMPUTING DEVICE

(71) Applicant: Ping An Technology (Shenzhen) Co., Ltd., Shenzhen (CN)

(72) Inventors: Jinghong Miao, San Jose, CA (US); Yuchuan Gou, Sunnyvale, CA (US); Ruei-Sung Lin, Redwood City, CA (US); Bo Gong, Belmont, CA (US); Mei Han, Palo Alto, CA (US)

(21) Appl. No.: 16/701,484

(22) Filed: Dec. 3, 2019

(51) Int. Cl. G06K 9/48; G06K 9/62; G06K 9/46; G06T 7/13; G06T 3/40; G06K 9/42; G06F 16/538; G06F 16/56; G06N 3/04; G06N 3/08

(52) U.S. Cl. CPC G06K 9/48; G06K 9/6201; G06K 9/4609; G06T 7/13; G06T 3/40; G06K 9/42; G06T 2207/20081; G06F 16/56; G06N 3/04; G06N 3/08; G06T 2207/20076; G06T 2207/20092; G06F 16/538

(57) ABSTRACT

An image generation method and a computing device using the method, includes creating an image database with a plurality of original images, and obtaining a plurality of first outline images of an object by detecting an outline of the object in each of the original images. Numerous first feature matrixes are obtained by calculating a feature matrix of each of the first outline images. A second feature matrix of a second outline image input by a user is calculated. A target feature matrix is selected from the plurality of first feature matrixes, the target feature matrix has a minimum difference as the second feature matrix. A target image corresponding to the target feature matrix is matched and displayed from the image database. The method and device allow detection of an object outline in an image input by users and the generation of an image with the detected outline.

### FIELD

The present disclosure relates to a technical field of artificial intelligence, specifically an image generation method and a computing device.

### BACKGROUND

Artificial Intelligence (AI) is developing, there is already an AI-based composition system, an AI-based writing poetry system, an AI-based image generation system.

The most successful model used for AI-based image generation is the anti-neural network model. The anti-neural network model has been able to generate various styles of images. Known anti-neural network model may not be able to control the content of the generated image and the outline of the objects therein. The reason is that the input of the anti-neural network model is a hidden variable, which belongs to a variable space that humans cannot directly read. Although there is a method for spatial interpretation of the variable space, most of the variable space cannot be completely decomposed. Therefore, it is technically difficult to generate a specific outline of images by modifying a value of the hidden variable.

A scheme for better AI image generation is needed.

### BRIEF DESCRIPTION OF THE DRAWINGS

FIG. 1 shows a schematic flow chart of an embodiment of an image generation method according to the present disclosure.

FIG. 2 shows a schematic structural diagram of an embodiment of an image generation device according to the present disclosure.

FIG. 3 shows a schematic structure of a computing device according to the present disclosure.

### DETAILED DESCRIPTION

The embodiments of the present disclosure are described with reference to the accompanying drawings. Described embodiments are merely embodiments which are a part of the present disclosure, and do not include every embodiment. All other embodiments obtained by those of ordinary skill in the art based on the embodiments of the present disclosure without creative efforts are within the scope of the claims.

Terms such as “first”, “second” and the like in the specification and in the claims of the present disclosure and the above drawings are used to distinguish between different objects, and are not intended to describe a specific order. Moreover, terms “include” and any variations of the term “include” are intended to indicate a non-exclusive inclusion. For example, a process, a method, a system, a product, or a device which includes a series of steps or units is not limited to the steps or units which are listed herein, but can include steps or units which are not listed, or can include other steps or units inherent to such processes, methods, products, and equipment.

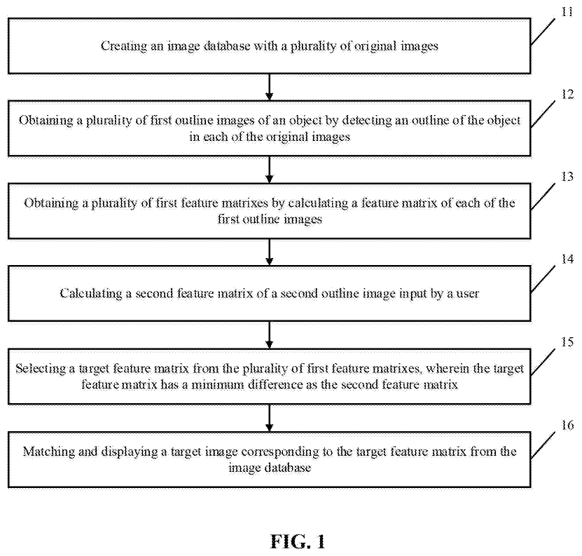

FIG. 1 shows a schematic flow chart of an embodiment of an image generation method according to the present disclosure.

As shown in FIG. 1, the image generation method applicable in a computing device can include the following steps. According to different requirements, the order of the steps in the flow may be changed, and some may be omitted. Within each step, sub-steps may be sub-numbered.

In block 11, creating an image database with a plurality of original images.

In one embodiment, a large number of different styles of original images can be acquired in advance, for example, Chinese landscape original images, oil original images of vases or other objects, landscape oil original images, seascape oil original images, etc., to create an image database.

The web crawler technology can be used to trawl for original images from webs. Styles of the images are different. Since the web crawler technology is known in prior art, and focus of the present disclosure is not on the web crawler technology, the present disclosure does not introduce web crawling.

The plurality of original images in the image database can be classified and stored according to different styles and different contents. Each image has an unique identification number. Different images correspond to different identification numbers. For example, image A has an identification number “001”, image B has an identification number “002”, and image C has an identification number “003”.

In some embodiments, after acquiring a plurality of original images, the method further includes: normalizing the original images.

The original images acquired in the plurality may have differences in format, size, or image quality. Therefore, after acquiring the plurality of original images, it is necessary to normalize each original image of the plurality of original images. The image database can be created using the normalized original images.

In some embodiments, the normalization of the original images includes: normalizing a format of each of the original images to a preset format, and normalizing a size of each of the original images to a preset target size.

Formats of these original images acquired from different sources may not be uniform. For example, some original images may be in TIF format, some original images may be in JPG format or JPEG format, and some original images may be in PNG format. Therefore, it is necessary to normalize the format of each original image.

Sizes of these original images acquired from different sources may not be uniform. For example, some original images are larger in size, and some are smaller in size. Therefore, it is necessary to normalize the size of each original image.

Encoding or conversion can be used to normalize the formats and sizes of the original images, or tools provided by open source software can be used to normalize the formats and sizes of the original images. Normalizing the formats and sizes of the plurality of original images can be done quickly and allow batch-importing when detecting outline of the original images.

In block 12, obtaining a plurality of first outline images of an object by detecting an outline of the object in each of the original images.

In some embodiments, the preset edge detection algorithm can be a holistically-nested edge detection (HED) algorithm, a Canny edge detection algorithm, a Sobel edge detection algorithm, a Prewitt edge detection algorithm, a Kirsch edge detection algorithm, a compass edge detection algorithm, or a Laplacian edge detection algorithm, etc.

In some embodiments, the outline of the object in each of the original images can be detected using the HED algorithm. The HED algorithm is a transfer learning based on a VGG16 model. Top five modules of the VGG16 model are extracted, and a convolution layer of each module is connected to a classifier. The classifier is composed of a convolution layer and a deconvolution layer. Finally, results of the five classifier are superimposed and placed into a convolution layer to obtain a pixel point probability distribution map. By applying the HED algorithm to all the original images in the image database, the outline of the objects with better effect can be detected.

In some embodiments, the obtaining of a plurality of first outline images by detecting an outline of the object in each of the original images includes:

121) obtaining a plurality of probability distribution maps by detecting pixel points in each of the original images using the holistically-nested edge detection (HED) algorithm;

122) determining target probabilities that are greater than or equal to a specified probability threshold in each of the probability distribution maps;

123) acquiring target pixel points corresponding to the target probabilities in each of the original images;

124) extracting the outline of the object in each of the original images according to the target pixel points.

In the above embodiment, since the HED algorithm outputs a probability distribution map of pixel points in each original image, the specified probability thresholds are different, the target probabilities greater than or equal to the specified probability thresholds in each original image are different, and the extracted outlines are different. The larger the probability threshold which is specified, the fewer will be the determined target probabilities greater than or equal to the specified probability thresholds, and the less detail information of the outline of the object is extracted. The smaller the probability threshold which is specified, the more will be the determined target probabilities greater than or equal to the specified probability thresholds, and the more detail information of the outline of the object is extracted.

Different types of images require different outlines due to differences in their content. For the landscape painting images, a user may pay more attention to an overall position and shape of the landscape, so a larger probability threshold can be specified to improve an efficiency of detecting the outline of the landscape. For the oil painting vase images, the user may pay more attention to details of flowers and leaves, so a small probability threshold can be specified to filter out more details of the flowers and leaves.

A human-computer interaction interface can be provided, for example, providing a display interface. The user can enter a probability threshold through the human-computer interaction interface. After the probability threshold is entered, the plurality of first outline images can be obtained by detecting the outline of the object in each of the original images in the image database. Thus, the user can automatically adjust the probability threshold according to needs of the details of the object being outlined, to adapt to different types of characteristics of images.

In some embodiments, the specified probability threshold is acquired by one or more of the following combinations:

A) acquiring a probability threshold entered in a probability threshold input box on the human-computer interaction interface;

In the above embodiment, the human-computer interaction interface can display the probability threshold input box. When the user clearly knows the probability threshold that should be entered, the probability threshold can be entered through the probability threshold input box.

B) acquiring an image type entered in an image type input box on the human-computer interaction interface, and acquiring a probability threshold corresponding to the entered image type;

In the above embodiment, the human-computer interaction interface can display the image type input box. For most users, especially those who are generating images for the first time, it may not be clear how large a probability threshold should be set. Several adjustments of the probability threshold will be required. The operation is very cumbersome and inconvenient. Therefore, the user can enter the image type in the image type input box, and the probability threshold corresponding to the entered image type can be automatically acquired according to a correspondence between image types and probability thresholds. For example, if an image type entered by the user is “landscape”, an acquired probability threshold will be 0.6 according to the landscape. If an image type entered by the user is “flower”, an acquired probability threshold will be 0.9 according to the flower.

C) acquiring an image type entered in an image type input box on the human-computer interaction interface, acquiring and displaying a probability threshold range corresponding to the entered image type, and acquiring a probability threshold entered in a probability threshold input box on the human-computer interaction interface, according to the probability threshold range.

In the above embodiment, the human-computer interaction interface can display the probability threshold input box and the image type input box. If the user is dissatisfied with the outline generated according to the acquired probability threshold corresponding to the entered image type, the probability threshold range corresponding to the image type entered by the user may be acquired first, and then the probability threshold is fine-tuned according to the probability threshold range.

In block 13, obtaining a plurality of first feature matrixes by calculating a feature matrix of each of the first outline images.

In order to better calculate the feature matrix of each of the first outline images, a feature matrix calculation model can be pre-trained. Such feature matrix of each can be calculated by the trained feature matrix calculation model.

In the above embodiment, the obtaining of the plurality of first feature matrixes by calculating the feature matrix of each of the first outline images includes:

131) down-sampling each of the first outline images to a preset size;

132) inputting each of the down-sampled first outline images into a trained VGG19 model;

133) acquiring an output of a second convolutional layer of a fifth convolutional module of the trained VGG19 model to obtain the plurality of first feature matrixes.

In some embodiments, the VGG19 model can be trained in advance using an ImageNet dataset, which is a large-scale visualization database for visual object recognition software research. ImageNet is like a network, and has multiple Nodes. Each node contains at least 500 images of an object and contains more than 20,000 categories. The VGG19 model trained based on the ImageNet data set has better ability to calculate feature matrix of outline images.

The down-sampled first outline images is used as an input of the trained VGG19 model, and an output of “Conv5_2” of the VGG19 model is used as feature matrix. For the same calculation of all the down-sampled first outline images in the image database, the plurality of first feature matrixes can be obtained.

If the preset size is 128×128, sizes of the first feature matrixes are 8×8×512.

In block 14, calculating a second feature matrix of a second outline image input by a user.

The user can input the second outline image through the human-computer interaction interface. The second outline image has only one outline, which is used to express the outline of an object of an image that the user desires to generate.

The second outline image is also down-sampled to a size of 128×128, and then input into the trained VGG19 model. A second feature matrix is obtained from the “Conv5_2” layer. A size of the second feature matrix is 8×8×512. A specific calculation process of the second feature matrix is not described in detail, as shown in block 13.

In block 15, selecting a target feature matrix from the plurality of first feature matrixes, wherein the target feature matrix has a minimum difference as the second feature matrix.

In the above embodiment, after obtaining the plurality of first feature matrixes and the second feature matrix, differences between each of the first feature matrixes and the second feature matrix is calculated and a minimum difference is determined. Finally, the target feature matrix corresponding to the minimum difference is selected from all the first feature matrices.

In some embodiments, the selecting of a target feature matrix having a minimum difference with the second feature matrix from the plurality of first feature matrixes includes:

151) sorting feature vectors of the second feature matrix from large to small;

152) acquiring top K feature vectors of the sorted second feature matrix;

153) determining positions of the top K feature vectors in the second feature matrix;

154) acquiring top K feature vectors corresponding to positions in each of the plurality of first feature matrixes;

155) calculating differences between the top K feature vectors of each of the first feature matrixes and the top K feature vectors of the second feature matrix;

156) determining a minimum difference from the differences as a target difference;

157) determining the target feature matrix corresponding to the target difference from the plurality of first feature matrixes.

In one embodiment, since the second outline image has more blank parts than the first outline images, most of the feature vectors of the second feature matrix are 0. Therefore, it is only needed to k feature vectors at corresponding positions from the first feature matrix and the second feature matrix to calculate differences, which greatly shortens calculation time and improve a calculation efficiency.

Exemplarily, assuming that the size of the first feature matrix and the second feature matrix are 8×8×512, the first feature matrix and the second feature matrix can be regarded as 64 512-dimensional feature vectors. The 64 512-dimensional feature vectors in the second feature matrix are respectively summed to obtain 64 sum values, and then a largest front K (K=3) feature vectors corresponding to a largest sum values are selected from the 64 512-dimensional feature vectors. The largest front K (K=3) feature vectors are the top K feature vectors of the sorted second feature matrix. Then the size of the second feature matrix is reduced from 8×8×512 to 3×512. The positions of the 3 feature vectors of the second feature matrix are 2, 50, and 37. The 2nd, 50th, and 37th feature vectors of each first feature matrix are acquired. Differences between the 2nd, 50th, and 37th feature vectors of each first feature matrix and the 2nd, 50th, and 37th feature vectors of the second feature matrix are calculated.

The less the difference, the larger will be the distance between the top K feature vectors of the first feature matrices and the top K feature vectors of the second feature matrix, and the corresponding two outline images are different. The greater the differences, the smaller will be the distance between the top K feature vectors of the first feature matrices and the top K feature vectors of the second feature matrix, and the corresponding two outline images are the same. When two outline images are completely the same, the difference is 0 and the distance is 0. When two outline images are completely different, the difference is 1 and the distance is 1. A first feature matrix having the minimum difference with the second feature matrix is selected from the plurality of first feature matrixes as the target feature matrix.

In Block 16, matching and displaying a target image corresponding to the target feature matrix from the image database.

In one embodiment, after the target feature matrix is obtained, the target image corresponding to the target feature matrix may be matched, and the matched target image will be an image desired by the user.

In some embodiments, the matching and displaying of a target image corresponding to the target feature matrix from the image database includes:

161) determining a target identification number corresponding to the target feature matrix, according to a mapping relationship between identification numbers of the original images and the feature matrixes;

162) matching and displaying the target image corresponding to the target identification number from the image database.

In the above embodiments, the image database not only stores the plurality of original images, but also stores identification numbers. There is a one-to-one mapping relationship between the identification numbers and the feature matrixes of the original images. The mapping relationship is stored as a dictionary data structure in the hard disk. The dictionary data structure may be an npy format.

Exemplarily, assuming that there are 5 original images stored in the database, and an identification number of a first image is 001 and a corresponding feature matrix is A. An identification number of a second image is 002 and a corresponding feature matrix is B. An identification number of a third image is 003 and a corresponding feature matrix is C. An identification number of a fourth image is 004 and a corresponding feature matrix is D, and an identification number of a fifth image is 005 and a corresponding feature matrix is E. The selected target feature matrix is C, and then the identification number 003 is determined as the target identification number. The third image corresponding to the target identification number 003 is matched as the target image from the image database.

The image generation method provided by embodiments of the present disclosure creates an image database in advance, and detects an outline of an object in each of the original images to obtain a plurality of first outline images. A plurality of first feature matrixes is obtained by calculating a feature matrix of each of the first outline images. When a user inputs a second outline image prepared in advance, a second feature matrix of the second outline image is calculated. A target feature matrix is selected from the plurality of first feature matrixes, wherein the target feature matrix has a minimum difference as the second feature matrix. Finally, a target image corresponding to the target feature matrix is matched from the image database and displayed. In this way, the matched target image has the same outline as the image input by the user. That is, according to the image input by the user, the image most similar to outline of the object of the input image can be found from the image database, thereby content of the generated image can be controlled. Applying such method to a field of image searching reduces time searching for similar images, and improves a search efficiency.

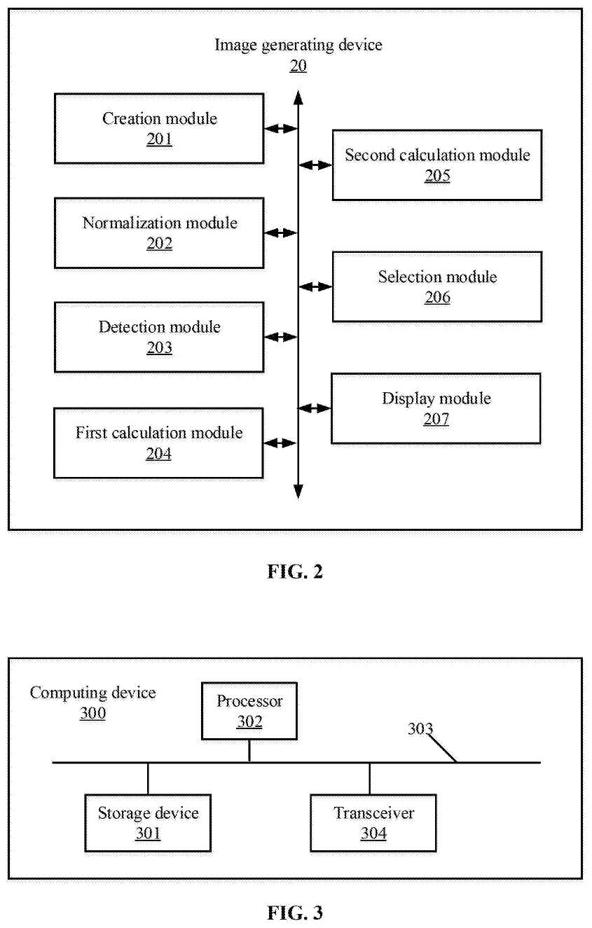

FIG. 2 shows a schematic structural diagram of an embodiment of an image generation device according to the present disclosure.

In some embodiments, an image generation device 20 can include a plurality of function modules consisting of program code segments. The program code of each program code segments in the image generation device 20 may be stored in a memory of a computing device and executed by the at least one processor to perform (described in detail in FIG. 1) a function of generating images.

In an embodiment, the image generation device 20 can be divided into a plurality of functional modules, according to the performed functions. The functional module can include: a creation module 201, a normalization module 202, a detection module 203, a first calculation module 204, a second calculation module 205, a selection module 206, and a display module 207. A module as referred to in the present disclosure refers to a series of computer program segments that can be executed by at least one processor and that are capable of performing fixed functions, which are stored in a memory. In this embodiment, the functions of each module will be detailed in the following embodiments.

The creation module 201 is configured to create an image database with a plurality of original images.

In one embodiment, a large number of different styles of original images can be acquired in advance, for example, Chinese landscape original images, oil original images of vases or other objects, landscape oil original images, seascape oil original images, etc., to create an image database.

The web crawler technology can be used to trawl for original images from webs. Styles of the images are different. Since the web crawler technology is known in prior art, and focus of the present disclosure is not on the web crawler technology, the present disclosure does not introduce web crawling.

The plurality of original images in the image database can be classified and stored according to different styles and different contents. Each image has an unique identification number. Different images correspond to different identification numbers. For example, image A has an identification number “001”, image B has an identification number “002”, and image C has an identification number “003”.

In some embodiments, the normalization module 202 is configured to normalize the original images, after acquiring a plurality of original images.

The original images acquired in the plurality may have differences in format, size or image quality. Therefore, after acquiring the plurality of original images, it is necessary to normalize each original image of the plurality of original images. The image database can be created using the normalized original images.

In some embodiments, the normalization of the original images includes: normalizing a format of each of the original images to a preset format, and normalizing a size of each of the original images to a preset target size.

Formats of these original images acquired from different sources may not be uniform. For example, some original images may be in TIF format, some original images may be in JPG format or JPEG format, and some original images may be in PNG format. Therefore, it is necessary to normalize the format of each original image.

Sizes of these original images acquired from different sources may not be uniform. For example, some original images are larger in size, and some are smaller in size. Therefore, it is necessary to normalize the size of each original image.

Encoding or conversion can be used to normalize the formats and sizes of the original images, or tools provided by open source software can be used to normalize the formats and sizes of the original images. Normalizing the formats and sizes of the plurality of original images can be done quickly and allow batch-importing when detecting outline of the original images.

The detection module 203 is configured to obtain a plurality of first outline images of an object by detecting an outline of the object in each of the original images.

In some embodiments, the preset edge detection algorithm can be a holistically-nested edge detection (HED) algorithm, a Canny edge detection algorithm, a Sobel edge detection algorithm, a Prewitt edge detection algorithm, a Kirsch edge detection algorithm, a compass edge detection algorithm, or a Laplacian edge detection algorithm, etc.

In some embodiments, the outline of the object in each of the original images can be detected using the HED algorithm. The HED algorithm is a transfer learning based on a VGG16 model. Top five modules of the VGG16 model are extracted, and a convolution layer of each module is connected to a classifier. The classifier is composed of a convolution layer and a deconvolution layer. Finally, results of the five classifier are superimposed and placed into a convolution layer to obtain a pixel point probability distribution map. By applying the HED algorithm to all the original images in the image database, the outline of the objects with better effect can be detected.

In some embodiments, the detection module 203 being configured to obtain the plurality of first outline images by detecting an outline of the object in each of the original images includes:

121) obtaining a plurality of probability distribution maps by detecting pixel points in each of the original images using the holistically-nested edge detection (HED) algorithm;

122) determining target probabilities that are greater than or equal to a specified probability threshold in each of the probability distribution maps;

123) acquiring target pixel points corresponding to the target probabilities in each of the original images;

124) extracting the outline of the object in each of the original images according to the target pixel points.

In the above embodiment, since the HED algorithm outputs a probability distribution map of pixel points in each original image, the specified probability thresholds are different, the target probabilities greater than or equal to the specified probability thresholds in each original image are different, and the extracted object outlines are different. The larger the probability threshold which is specified, the fewer will be the determined target probabilities greater than or equal to the specified probability thresholds, and the less detail information of the outline of the object is extracted. The smaller the probability threshold which is specified, the more will be the determined target probabilities greater than or equal to the specified probability thresholds, and the more detail information of the outline of the object is extracted.

Different types of images require different object outlines due to differences in their content. For the landscape painting images, a user may pay more attention to an overall position and shape of the landscape as an object, so a larger probability threshold can be specified to improve an efficiency of detecting the outline of the landscape. For the oil painting vase images, the user may pay more attention to details of flowers and leaves as an object, so a small probability threshold can be specified to filter out more details of the flowers and leaves.

A human-computer interaction interface can be provided, for example, providing a display interface. The user can enter a probability threshold through the human-computer interaction interface. After the probability threshold is entered, the plurality of first outline images can be obtained by detecting the outline of the object in each of the original images in the image database. Thus, the user can automatically adjust the probability threshold according to needs of the details of the outline, to adapt to different types of characteristics of images.

In some embodiments, the specified probability threshold is acquired by one or more of the following combinations:

A) acquiring a probability threshold entered in a probability threshold input box on the human-computer interaction interface;

In the above embodiment, the human-computer interaction interface can display the probability threshold input box. When the user clearly knows the probability threshold that should be entered, the probability threshold can be entered through the probability threshold input box.

B) acquiring an image type entered in an image type input box on the human-computer interaction interface, and acquiring a probability threshold corresponding to the entered image type;

In the above embodiment, the human-computer interaction interface can display the image type input box. For most users, especially those who are generating images for the first time, it may not be clear how large a probability threshold should be set. Several adjustments of the probability threshold will be required. The operation is very cumbersome and inconvenient. Therefore, the user can enter the image type in the image type input box, and the probability threshold corresponding to the entered image type can be automatically acquired according to a correspondence between image types and probability thresholds. For example, if an image type entered by the user is “landscape”, an acquired probability threshold will be 0.6 according to the landscape. If an image type entered by the user is “flower”, an acquired probability threshold will be 0.9 according to the flower.

C) acquiring an image type entered in an image type input box on the human-computer interaction interface, acquiring and displaying a probability threshold range corresponding to the entered image type, and acquiring a probability threshold entered in a probability threshold input box on the human-computer interaction interface, according to the probability threshold range.

In the above embodiment, the human-computer interaction interface can display the probability threshold input box and the image type input box. If the user is dissatisfied with the outline generated according to the acquired probability threshold corresponding to the entered image type, the probability threshold range corresponding to the image type entered by the user may be acquired first, and then the probability threshold is fine-tuned according to the probability threshold range.

The first calculation module 204 is configured to obtain a plurality of first feature matrixes by calculating a feature matrix of each of the first outline images.

In order to better calculate the feature matrix of each of the first outline images, a feature matrix calculation model can be pre-trained. Such feature matrix of each can be calculated by the trained feature matrix calculation model.

In the above embodiment, the first calculation module 204 being configured to obtain the plurality of first feature matrixes by calculating a feature matrix of each first outline images includes:

131) down-sampling each of the first outline images to a preset size;

132) inputting each of the down-sampled first outline images into a trained VGG19 model;

133) acquiring an output of a second convolutional layer of a fifth convolutional module of the trained VGG19 model to obtain the plurality of first feature matrixes.

In some embodiments, the VGG19 model can be trained in advance using an ImageNet dataset, which is a large-scale visualization database for visual object recognition software research. ImageNet is like a network, and has multiple Nodes. Each node contains at least 500 images of an object and contains more than 20,000 categories. The VGG19 model trained based on the ImageNet data set has better ability to calculate feature matrix of outline images.

The down-sampled first outline images is used as an input of the trained VGG19 model, and an output of “Conv5_2” of the VGG19 model is used as feature matrix. For the same calculation of all the down-sampled first outline images in the image database, the plurality of first feature matrixes can be obtained.

If the preset size is 128×128, sizes of the first feature matrixes are 8×8×512.

The second calculation module 205 is configured to calculate a second feature matrix of a second outline image input by a user.

The user can input the second outline image through the human-computer interaction interface. The second outline image has only one type of object outline, which is used to express the outline of an image that the user desires to generate.

The second outline image is also down-sampled to a size of 128×128, and then input into the trained VGG19 model. A second feature matrix is obtained from the “Conv5_2” layer. A size of the second feature matrix is 8×8×512. A specific calculation process of the second feature matrix is not described in detail, as shown in block 13.

The selection module 206 is configured to select a target feature matrix from the plurality of first feature matrixes, wherein the target feature matrix has a minimum difference as the second feature matrix.

In the above embodiment, after obtaining the plurality of first feature matrixes and the second feature matrix, differences between each of the first feature matrixes and the second feature matrix is calculated and a minimum difference is determined. Finally, the target feature matrix corresponding to the minimum difference is selected from all the first feature matrices.

In some embodiments, the selection module 206 being configured to select the target feature matrix having a minimum difference with the second feature matrix from the plurality of first feature matrixes includes:

151) sorting feature vectors of the second feature matrix from large to small;

152) acquiring top K feature vectors of the sorted second feature matrix;

153) determining positions of the top K feature vectors in the second feature matrix;

154) acquiring top K feature vectors corresponding to positions in each of the plurality of first feature matrixes;

155) calculating differences between the top K feature vectors of each of the first feature matrixes and the top K feature vectors of the second feature matrix;

156) determining a minimum difference from the differences as a target difference;

157) determining the target feature matrix corresponding to the target difference from the plurality of first feature matrixes.

In one embodiment, since the second outline image has more blank parts than the first outline images, most of the feature vectors of the second feature matrix are 0. Therefore, it is only needed to select k feature vectors at corresponding positions from the first feature matrix and the second feature matrix to calculate differences, which greatly shortens calculation time and improves a calculation efficiency.

Exemplarily, assuming that the size of the first feature matrix and the second feature matrix are 8×8×512, the first feature matrix and the second feature matrix can be regarded as 64 512-dimensional feature vectors. The 64 512-dimensional feature vectors in the second feature matrix are respectively summed to obtain 64 sum values, and then a largest front K (K=3) feature vectors corresponding to a largest sum values are selected from the 64 512-dimensional feature vectors. The largest front K (K=3) feature vectors are the top K feature vectors of the sorted second feature matrix. Then the size of the second feature matrix is reduced from 8×8×512 to 3×512. The positions of the 3 feature vectors of the second feature matrix are 2, 50, and 37. The 2nd, 50th, and 37th feature vectors of each first feature matrix are acquired. Differences between the 2nd, 50th, and 37th feature vectors of each first feature matrix and the 2nd, 50th, and 37th feature vectors of the second feature matrix is calculated.

The less the difference, the larger will be the distance between the top K feature vectors of the first feature matrices and the top K feature vectors of the second feature matrix, and the corresponding two outline images are different. The greater the difference, the smaller will be the distance between the top K feature vectors of the first feature matrices and the top K feature vectors of the second feature matrix, and the corresponding two outline images are the same. When two outline images are completely the same, the difference is 0 and the distance is 0. When two outline images are completely different, the difference is 1 and the distance is 1. A first feature matrix having the minimum difference with the second feature matrix is selected from the plurality of first feature matrixes as the target feature matrix.

The displaying module 207 is configured to match and display a target image corresponding to the target feature matrix from the image database.

In one embodiment, after the target feature matrix is obtained, the target image corresponding to the target feature matrix may be matched, and the matched target image will be an image desired by the user.

In some embodiments, the displaying module 207 being configured to match and display the target image corresponding to the target feature matrix from the image database includes:

161) determining a target identification number corresponding to the target feature matrix, according to a mapping relationship between identification numbers of the original images and the feature matrixes;

162) matching and displaying the target image corresponding to the target identification number from the image database.

In the above embodiments, the image database not only stores the plurality of original images, but also stores identification numbers. There is a one-to-one mapping relationship between the identification numbers and the feature matrixes of the original images. The mapping relationship is stored as a dictionary data structure in the hard disk. The dictionary data structure may be a npy format.

Exemplarily, assuming that there are 5 original images stored in the database, and an identification number of a first image is 001 and a corresponding feature matrix is A. An identification number of a second image is 002 and a corresponding feature matrix is B. An identification number of a third image is 003 and a corresponding feature matrix is C. An identification number of a fourth image is 004 and a corresponding feature matrix is D, and an identification number of a fifth image is 005 and a corresponding feature matrix is E. The selected target feature matrix is C, and then the identification number 003 is determined as the target identification number. The third image corresponding to the target identification number 003 is matched as the target image from the image database.

The image generation device provided by embodiments of the present disclosure creates an image database in advance, and detects an outline of an object in each of the original images to obtain a plurality of first outline images. A plurality of first feature matrixes is obtained by calculating a feature matrix of each of the first outline images. When a user inputs a second outline image prepared in advance, a second feature matrix of the second outline image is calculated. A target feature matrix is selected from the plurality of first feature matrixes, wherein the target feature matrix has a minimum difference as the second feature matrix. Finally, a target image corresponding to the target feature matrix is matched from the image database and displayed. In this way, the matched target image has the same outline as the image input by the user. That is, according to the image input by the user, the image most similar to the outline of the input image can be found from the image database, thereby content of the generated image can be controlled. Applying such method to a field of image searching reduces time searching for similar images, and improves a search efficiency.

FIG. 3 shows a schematic structural diagram of a computing device according to an embodiment of the present disclosure.

As shown in FIG. 3, the computing device 300 may include: at least one storage device 301, at least one processor 302, at least one communication bus 303, and a transceiver 304.

The structure of the computing device 300 shown in FIG. 3 does not constitute a limitation of the embodiments of the present disclosure. The computing device 300 may be a bus type structure or a star type structure, and the computing device 300 may also include more or less hardware or software than as illustrated, or it may have different component arrangements.

In at least one embodiment, the computing device 300 can include a terminal that is capable of automatically performing numerical calculations and/or information processing in accordance with pre-set or stored instructions. The hardware of the terminal can include, but is not limited to, a microprocessor, an application specific integrated circuit, programmable gate arrays, digital processors, and embedded devices. The computing device 300 may further include an electronic device. The electronic device can interact with a user through a keyboard, a mouse, a remote controller, a touch panel or a voice control device, for example, individual computers, tablets, smartphones, digital cameras, etc.

It should be noted that the computing device 300 is merely an example, other existing or future electronic products may be included in the scope of the present disclosure and are included in the reference.

In some embodiments, the storage device 301 stores program codes of computer readable programs and various data, such as the image generation device 20 installed in the computing device 300. The storage device 301 can include a read-only memory (ROM), a programmable read-only memory (PROM), an erasable programmable read only memory (EPROM), an one-time programmable read-only memory (OTPROM), an electronically-erasable programmable read-only memory (EEPROM), a compact disc read-only memory (CD-ROM), or other optical disk storage, magnetic disk storage, magnetic tape storage, or any other non-transitory storage medium readable by the computing device 300 that can be used to carry or store data.

In some embodiments, the at least one processor 302 may be composed of an integrated circuit, for example, may be composed of a single packaged integrated circuit, or may be composed of multiple integrated circuits of same function or different functions. The at least one processor 302 can include one or more central processing units (CPU), a microprocessor, a digital processing chip, a graphics processor, and various control chips. The at least one processor 302 is a control unit of the computing device 300, which connects various components of the computing device 300 using various interfaces and lines. By running or executing a computer program or modules stored in the storage device 301, and by invoking the data stored in the storage device 301, the at least one processor 302 can perform various functions of the computing device 300 and process data of the computing device 300.

In some embodiments, the least one bus 303 achieves intercommunication between the storage device 301 and the at least one processor 302, and other components of the computing device 300.

Although not shown, the computing device 300 may further include a power supply (such as a battery) for powering various components. Preferably, the power supply may be logically connected to the at least one processor 302 through a power management device, thereby, the power management device manages functions such as charging, discharging, and power management. The power supply may include various power sources, a recharging device, a power failure detection circuit, a power converter or inverter, a power status indicator, and the like. The computing device 300 may further include various sensors, such as a BLUETOOTH module, a WI-FI module and the like, and details are not described herein.

It should be understood that the described embodiments are for illustrative purposes only and are not limited by the scope of the present disclosure.

The above-described integrated unit implemented in a form of software function modules can be stored in a computer readable storage medium. The above software function modules are stored in a storage medium, and includes a plurality of instructions for causing a computing device (which may be a personal computer, or a network device, etc.) or a processor to execute the method according to various embodiments of the present disclosure.

In a further embodiment, referring to FIG. 2, the at least one processor 302 can execute an operating system and various types of applications (such as the image generation device 20) installed in the computing device 300, program codes, and the like. For example, the at least one processor 302 can execute the modules 201-207.

In at least one embodiment, the storage device 301 stores program codes. The at least one processor 302 can invoke the program codes stored in the storage device 301 to perform related functions. For example, the modules described in FIG. 2 are program codes stored in the storage device 301 and executed by the at least one processor 302, to implement the functions of the various modules.

In at least one embodiment, the storage device 301 stores a plurality of instructions that are executed by the at least one processor 302 to implement all or part of the steps of the method described in the embodiments of the present disclosure.

Specifically, the storage device 301 stores the plurality of instructions which when executed by the at least one processor 302 causes the at least one processor 302 to: create an image database with a plurality of original images; obtain a plurality of first outline images of an object by detecting an outline of the object in each of the original images; obtain a plurality of first feature matrixes by calculating a feature matrix of each of the first outline images; calculate a second feature matrix of a second outline image input by a user; select a target feature matrix from the plurality of first feature matrixes, wherein the target feature matrix has a minimum difference as the second feature matrix; and match and display a target image corresponding to the target feature matrix from the image database.

Specifically, the at least one processor 302 to select the target feature matrix from the plurality of first feature matrixes includes:

sort feature vectors of the second feature matrix from large to small;

acquire top K feature vectors of the sorted second feature matrix;

determine positions of the top K feature vectors in the second feature matrix;

acquire top K feature vectors corresponding to positions in each of the plurality of first feature matrixes;

calculating differences between the top K feature vectors of each of the first feature matrixes and the top K feature vectors of the second feature matrix;

determine a minimum difference from the differences as a target difference; and

determine the target feature matrix corresponding to the target difference from the plurality of first feature matrixes.

Specifically, the at least one processor 302 to obtain the plurality of first outline images of the object in each of the original images include:

obtain a plurality of probability distribution maps by detecting pixel points in each of the original images using a holistically-nested edge detection (HED) algorithm;

determine target probabilities that are greater than or equal to a specified probability threshold in each of the probability distribution maps;

acquire target pixel points corresponding to the target probabilities in each of the original images; and

extract the outline of the object in each of the original images according to the target pixel points.

Specifically, the at least one processor acquires the specified probability threshold by one or more of the following combinations:

acquiring a probability threshold entered in a probability threshold input box on a human-computer interaction interface displayed on the computing device; or

acquiring an image type entered in an image type input box on the human-computer interaction interface, and acquiring a probability threshold corresponding to the entered image type; or

acquiring the image type entered in the image type input box on the human-computer interaction interface, acquiring and displaying a probability threshold range corresponding to the entered image type, and acquiring a probability threshold entered in a probability threshold input box on the human-computer interaction interface, according to the probability threshold range.

Specifically, the at least one processor 302 to obtain a plurality of first feature matrixes by calculating a feature matrix of each of the first outline images include:

down-sample each of the first outline images to a preset size;

input each of the down-sampled first outline images into a trained VGG19 model;

acquire an output of a second convolutional layer of a fifth convolutional module of the trained VGG19 model to obtain the plurality of first feature matrixes.

Specifically, the at least one processor 302 further to:

normalize a format of each of the original images to a preset format; and

normalize a size of each of the original images to a preset target size.

Such non-transitory storage medium carries instructions that, when executed by a processor of a computing device, causes the computing device to perform an image generation method, the method comprising: creating an image database with a plurality of original images; obtaining a plurality of first outline images of an object by detecting an outline of the object in each of the original images; obtaining a plurality of first feature matrixes by calculating a feature matrix of each of the first outline images; calculating a second feature matrix of a second outline image input by a user; selecting a target feature matrix from the plurality of first feature matrixes, wherein the target feature matrix has a minimum difference as the second feature matrix; and matching and displaying a target image corresponding to the target feature matrix from the image database.

The embodiments of the above method are expressed as a series of a combination of actions, but those skilled in the art should understand that the present disclosure is not limited by the described action sequence. According to the present disclosure, some steps in the above embodiments can be performed in other sequences or performed simultaneously. Secondly, those skilled in the art should also understand that the embodiments described in the specification are all optional embodiments, and the actions and units involved are not necessarily required by the present disclosure.

In the above embodiments, descriptions of each embodiment have a different focus, and when there is no detail part in a certain embodiment, the relevant parts of other embodiments can be referred to.

In several embodiments provided in the preset application, it should be understood that the disclosed apparatus can be implemented in other ways. For example, the device embodiments described above are merely illustrative. For example, divisions of the unit are only logical function divisions, and there can be other manners of division in actual implementation.

The modules described as separate components may or may not be physically separated, and the components displayed as modules may or may not be physical units. That is, they can be located in one place, or distributed to multiple network units. Some or all of the modules can be selected according to actual needs to achieve the purpose of the method.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

It is apparent to those skilled in the art that the present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims, all changes in the meaning and scope of equivalent elements are to be included in the present disclosure. Any reference signs in the claims should not be construed as limiting the claim.

The above embodiments are only used to illustrate a technical solution and not as restrictions on the technical solution. Although the present disclosure has been described in detail with reference to the above embodiments, those skilled in the art should understand that the technical solutions described in one embodiments can be modified, or some of technical features can be equivalently substituted, and these modifications or substitutions do not detract from the essence of the technical solutions or restrict the scope of the technical solution.

We claim:

1. An image generation method applicable in a computing device, the method comprising:
creating an image database with a plurality of original images;
obtaining a plurality of first outline images of an object by detecting an outline of the object in each of the original images;
obtaining a plurality of first feature matrixes by calculating a feature matrix of each of the first outline images;
calculating a second feature matrix of a second outline image input by a user;
selecting a target feature matrix from the plurality of first feature matrixes, wherein the target feature matrix has a minimum difference as the second feature matrix; and
matching and displaying a target image corresponding to the target feature matrix from the image database.

2. The image generation method of claim 1, wherein the method of selecting the target feature matrix from the plurality of first feature matrixes comprises:
sorting feature vectors of the second feature matrix from large to small;
acquiring top K feature vectors of the sorted second feature matrix;
determining positions of the top K feature vectors in the second feature matrix;
acquiring top K feature vectors corresponding to positions in each of the plurality of first feature matrixes;
calculating differences between the top K feature vectors of each of the first feature matrixes and the top K feature vectors of the second feature matrix;
determining a minimum difference from the differences as a target difference; and
determining the target feature matrix corresponding to the target difference from the plurality of first feature matrixes.

3. The image generation method of claim 1, wherein the method of obtaining the plurality of first outline images of the object in each of the original images comprises:
obtaining a plurality of probability distribution maps by detecting pixel points in each of the original images using a holistically-nested edge detection (HED) algorithm;
determining target probabilities that are greater than or equal to a specified probability threshold in each of the probability distribution maps;
acquiring target pixel points corresponding to the target probabilities in each of the original images; and
extracting the outline of the object in each of the original images according to the target pixel points.

4. The image generation method of claim 3, wherein the method of acquiring the specified probability threshold by one or more of the following combinations:
acquiring a probability threshold entered in a probability threshold input box on a human-computer interaction interface displayed on the computing device; or
acquiring an image type entered in an image type input box on the human-computer interaction interface, and acquiring a probability threshold corresponding to the entered image type.

5. The image generation method of claim 3, wherein the method of acquiring the specified probability threshold by one or more of the following combinations:
acquiring the image type entered in the image type input box on the human-computer interaction interface;
acquiring and displaying a probability threshold range corresponding to the entered image type; and
acquiring a probability threshold entered in a probability threshold input box on the human-computer interaction interface, according to the probability threshold range.

6. The image generation method of claim 1, wherein the method of obtaining the plurality of first feature matrixes by calculating a feature matrix of each of the first outline images comprises:
down-sampling each of the first outline images to a preset size;
inputting each of the down-sampled first outline images into a trained VGG19 model; and
acquiring an output of a second convolutional layer of a fifth convolutional module of the trained VGG19 model to obtain the plurality of first feature matrixes.

7. The image generation method of claim 1, before obtaining the plurality of first outline images of the object in each of the original images, the image generation method further comprising:
normalizing a format of each of the original images to a preset format; and
normalizing a size of each of the original images to a preset target size.

8. A computing device, comprising:
at least one processor; and
a storage device storing one or more programs which when executed by the at least one processor, causes the at least one processor to:
create an image database with a plurality of original images;
obtain a plurality of first outline images of an object by detecting an outline of the object in each of the original images;
obtain a plurality of first feature matrixes by calculating a feature matrix of each of the first outline images;
calculate a second feature matrix of a second outline image input by a user;
select a target feature matrix from the plurality of first feature matrixes, wherein the target feature matrix has a minimum difference as the second feature matrix; and
match and display a target image corresponding to the target feature matrix from the image database.

9. The computing device of claim 8, wherein the at least one processor to select the target feature matrix from the plurality of first feature matrixes comprises:
sort feature vectors of the second feature matrix from large to small;
acquire top K feature vectors of the sorted second feature matrix;
determine positions of the top K feature vectors in the second feature matrix;
acquire top K feature vectors corresponding to positions in each of the plurality of first feature matrixes;
calculate differences between the top K feature vectors of each of the first feature matrixes and the top K feature vectors of the second feature matrix;
determine a minimum difference from the differences as a target difference; and
determine the target feature matrix corresponding to the target difference from the plurality of first feature matrixes.

10. The computing device of claim 8, wherein the at least one processor to obtain the plurality of first outline images of the object in each of the original images comprises:
obtain a plurality of probability distribution maps by detecting pixel points in each of the original images using a holistically-nested edge detection (HED) algorithm;
determine target probabilities that are greater than or equal to a specified probability threshold in each of the probability distribution maps;
acquire target pixel points corresponding to the target probabilities in each of the original images; and
extract the outline of the object in each of the original images according to the target pixel points.

11. The computing device of claim 10, wherein the at least one processor acquires the specified probability threshold by one or more of the following combinations:
acquiring a probability threshold entered in a probability threshold input box on a human-computer interaction interface displayed on the computing device; or
acquiring an image type entered in an image type input box on the human-computer interaction interface, and acquiring a probability threshold corresponding to the entered image type.

12. The computing device of claim 10, wherein the at least one processor acquires the specified probability threshold by one or more of the following combinations:
acquiring the image type entered in the image type input box on the human-computer interaction interface;
acquiring and displaying a probability threshold range corresponding to the entered image type; and
acquiring a probability threshold entered in a probability threshold input box on the human-computer interaction interface, according to the probability threshold range.

13. The computing device of claim 8, wherein the at least one processor to obtain the plurality of first feature matrixes by calculating a feature matrix of each of the first outline images comprises:
down-sample each of the first outline images to a preset size;
input each of the down-sampled first outline images into a trained VGG19 model;
acquire an output of a second convolutional layer of a fifth convolutional module of the trained VGG19 model to obtain the plurality of first feature matrixes.

14. The computing device of claim 8, before to obtain the plurality of first outline images of the object in each of the original images, the at least one processor further to:
normalize a format of each of the original images to a preset format; and
normalize a size of each of the original images to a preset target size.

15. A non-transitory storage medium having stored thereon instructions that, when executed by a processor of a computing device, causes the computing device to perform an image generation method, the method comprising:
creating an image database with a plurality of original images;
obtaining a plurality of first outline images of an object by detecting an outline of the object in each of the original images;
obtaining a plurality of first feature matrixes by calculating a feature matrix of each of the first outline images;
calculating a second feature matrix of a second outline image input by a user;
selecting a target feature matrix from the plurality of first feature matrixes, wherein the target feature matrix has a minimum difference as the second feature matrix; and
matching and displaying a target image corresponding to the target feature matrix from the image database.

16. The non-transitory storage medium of claim 15, wherein the method of selecting the target feature matrix from the plurality of first feature matrixes comprises:
sorting feature vectors of the second feature matrix from large to small;
acquiring top K feature vectors of the sorted second feature matrix;
determining positions of the top K feature vectors in the second feature matrix;
acquiring top K feature vectors corresponding to positions in each of the plurality of first feature matrixes;
calculating differences between the top K feature vectors of each of the first feature matrixes and the top K feature vectors of the second feature matrix;
determining a minimum difference from the differences as a target difference; and
determining the target feature matrix corresponding to the target difference from the plurality of first feature matrixes.

17. The non-transitory storage medium of claim 15, wherein the method of obtaining the plurality of first outline images of the object in each of the original images comprises:
obtaining a plurality of probability distribution maps by detecting pixel points in each of the original images using a holistically-nested edge detection (HED) algorithm;
determining target probabilities that are greater than or equal to a specified probability threshold in each of the probability distribution maps;
acquiring target pixel points corresponding to the target probabilities in each of the original images; and
extracting the outline of the object in each of the original images according to the target pixel points.

18. The non-transitory storage medium of claim 17, wherein the method of acquiring the specified probability threshold by one or more of the following combinations:
acquiring a probability threshold entered in a probability threshold input box on a human-computer interaction interface displayed on the computing device; or
acquiring an image type entered in an image type input box on the human-computer interaction interface, and acquiring a probability threshold corresponding to the entered image type.

19. The non-transitory storage medium of claim 17, wherein the method of acquiring the specified probability threshold by one or more of the following combinations:
acquiring the image type entered in the image type input box on the human-computer interaction interface;
acquiring and displaying a probability threshold range corresponding to the entered image type; and
acquiring a probability threshold entered in a probability threshold input box on the human-computer interaction interface, according to the probability threshold range.

20. The non-transitory storage medium of claim 15, wherein the method of obtaining the plurality of first feature matrixes by calculating a feature matrix of each of the first outline images comprises:
down-sampling each of the first outline images to a preset size;
inputting each of the down-sampled first outline images into a trained VGG19 model;
acquiring an output of a second convolutional layer of a fifth convolutional module of the trained VGG19 model to obtain the plurality of first feature matrixes.
